(19) United States
(12) Patent Application Publication
(10) Pub. No.: US 2004/0007280 A1
(43) Pub. Date: Jan. 15, 2004

(54) Tube blank and method of producing glass receptacles from a tube blank

(75) Inventors: Heinz Rausch, Bayreuth (DE); Erhard Dick, Pechbrunn (DE)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: Schott Glas

(21) Appl. No.: 10/441,268

(22) Filed: May 19, 2003

(30) Foreign Application Priority Data
Jun. 5, 2002 (DE) DE 102 24 833.8

(51) Int. Cl. F16L 9/00

(52) U.S. Cl. 138/177; 138/178; 138/DIG. 11

(57) ABSTRACT

A tube blank is disclosed for producing glass receptacles, in particular glass tube vials, glass ampules, or glass syringes, particularly those suitable for pharmaceutical applications, having a tube wall, including two end regions—a first end region and the second end region—the first end region being sealed to form a floor and a ventilation hole being introduced into the tube wall in the region of the end region, distinguished in that the tube end characterizing the second end region has an opening.

The present invention relates to a tube blank for the production of glass receptacles, in particular glass tube vials, glass ampules, and glass syringes in the pharmaceutical field, particularly having the features of the preamble of claim 1, as well as a method of producing glass receptacles, particularly to be filled with pharmaceutical products, from a tube blank.

A method of producing glass tube vials from a glass tube blank is previously known from the publication European Patent B 111 710. In this case, the glass tube blank is formed from a continuous glass bar. For this purpose, a tube length is detached from the glass tube strand and softened on both ends. The softened ends are drawn out axially until the glass tube collapses in this region and closed tube ends are thus obtained. A point-shaped opening is applied in the direct proximity of one of the two closed tube ends and the tube length prepared in this way is inserted in the form of a tube blank into a manufacturing machine and processed there into glass vials. The tube blank is inserted in the vertical direction into the manufacturing machine in such a way that the point-shaped opening lies on the bottom in the vertical direction. The tube wall is moderately heated on the upper end. Above the point-shaped opening, the tube length is then cut through thermally, a floor also temporarily forming on the remaining tube blank, which, however, immediately splits again due to the overpressure which builds up. At this location, the mouth of the first tube vial is formed. At a distance from this location which corresponds to the length of the tube vial, the tube blank is then cut through thermally again, the floor of the first tube vial and a further floor being formed simultaneously from the remaining tube, which, however, again immediately splits due to the internal overpressure which builds up. These method steps are repeated on the remaining tube blank, through which individual tube vials arise, which have cleanliness suitable for pharmaceutical applications.

The tube blanks themselves, which may be implemented as a tube blank, closed on both sides, having an opening sealable using a film, as described in German Utility Model 82 32 133 U1 are typically produced at a different time than the actual production of the glass receptacles. These blanks are then packaged into tube packages according to a method such as that described, for example, in the publication German Patent Application A-27 29 966, they, in the densest packing, lying next to and on top of one another, being enclosed by a shroud made of flexible material. In this doubly-protected state, they then reach the glass receptacle producer, who uses the method already described. To completely seal the individual tube blanks, the point-shaped opening, which functions as a ventilation hole, is also resealed by a film. This film is constituted in such a way that it softens upon moderate heating and then splits open under a slight pressure or is made of a material which combusts without a residue. In this way, the cleanliness necessary for pharmaceutical applications is ensured. However, the manufacturing of the tube blank is distinguished by an elevated outlay in this case. Furthermore, a part of the tube length of the tube blank is always discarded to manufacture glass receptacles, in particular glass receptacles for pharmaceutical applications, specifically the part having the ventilation hole and the remaining part of the tube blank having a shorter length than the tube vial upon division into the tube vial lengths. Furthermore, it has also been observed that, from a tube blank of this type in accordance with the method described, a specific rate of faulty glass receptacles may only be prevented through precise tailoring of the individual process parameters during the glass receptacle production.

The present invention is therefore based on the object of providing a method of producing glass receptacles, in particular for pharmaceutical applications, for example in the form of glass tube vials, glass ampules, and glass syringes, which is distinguished by high cost-effectiveness. In this case, optimum usage of the entire length of the tube blank is particularly desired. Furthermore, the outlay for manufacturing and control technology for the production of the glass receptacles is to be kept as low as possible and/or is to be distinguished by a large tolerance range.

The achievement of the object according to the present invention is characterized by the features of claims 1 and 5. Advantageous embodiments are described in the subclaims.

The tube blank according to the present invention for producing glass receptacles, particularly those suitable for pharmaceutical applications, in particular glass tube vials, glass ampules, and glass syringes, includes a tube wall having two end regions, a first end region of the tube wall being closed to form a floor. At least one ventilation hole is provided in the tube wall in the region of the first end region. The hole is preferably implemented perpendicularly to the tube blank axis. The diameter of this ventilation hole is preferably in a range from >0 to <1% of the open area present in a typical tube open on both sides. According to the present invention, the other, second end region is free of a seal, i.e., it has an opening or is completely open. To manufacture a tube blank of this type, a tube length is detached from a continuous glass tube strand. One of the two open ends of this tube length is softened and drawn out, using a force which acts in the axial direction, until the tube collapses and thus a first floor, which is planar or curved slightly inward, i.e., directed toward the inner chamber delimited by the tube wall, is made. After sealing of the one end region, the ventilation hole is then introduced into the tube wall in the region of this end region. It may be burned in, for example, using a spot burner. The detachment from a continuous glass tube strand may be distinguished by a somewhat elevated particle load in the region of the open end. However, it has been determined that in connection with the method according to the present invention for producing glass receptacles, particularly glass receptacles suitable for pharmaceutical applications, this disadvantage is compensated again by the method steps which then follow, and glass receptacles having a very high cleanliness, which are therefore suitable for pharmaceutical applications, may nonetheless be produced. The tube blank according to the present invention is therefore distinguished by a lower manufacturing technology outlay than the related art described. Furthermore, no separate measures are necessary for the transport of the tube blank to the actual manufacturing location for the glass receptacles, and the method of packing in tube packages already known from the related art may be used.

There are no restrictions in regard to the implementation of the floor on the tube blank. It may be implemented as planar or curved slightly inward. In this case, the geometry of the floor is a function of the temperature and the strength of the force which acts on the tube end region to be sealed.

In order to begin with the production of glass receptacles starting from the open tube end region, the open end region advantageously has a run-out of >0 and ≦1 mm, preferably ≦0.8 mm.

To manufacture the glass receptacles, particularly those suitable for use in pharmaceutical fields, in particular in the form of glass vials, glass ampules, or glass syringes, from a tube blank designed according to the present invention, the tube blank is placed in a manufacturing machine and processed there into the glass tube receptacles. According to the present invention, the tube blank is preferably inserted vertically into the manufacturing machine in such a way that the closed end region having the ventilation hole is located on top in the vertical direction. The second, open end region is then located on the bottom in the vertical direction. The manufacturing may immediately be begun on the second, open end region, in that it is heated and the desired mouth form is shaped. At an interval corresponding to the length of the glass receptacle, the tube blank is then cut through thermally, starting from the shaped mouth, the floor of the glass receptacle forming simultaneously during this process. This floor may be implemented as planar or with a curvature directed into the inner chamber delimited by the tube wall. The individual method steps are then continuously repeated on the tube blank, further glass receptacles arising. Preferably, the glass tube receptacle already manufactured is removed from the guide of the tube blank, so that the remaining tube blank, having the now open end region, may be pushed into the position of the glass receptacle now removed. This offers the advantage that the heating and shaping unit for producing the mouth does not have to be displaced and, if the tube blank is arranged vertically, it may assume this position solely due to gravity. An essential advantage of this achievement of the object is that the manufacturing of the glass receptacles may begin immediately, without discarding material of the tube blank, and, furthermore, due to the ventilation hole, which is always present, the pressure ratios in the tube blank may be controlled easily, so that no damage or faulty glass receptacles arise due to possible pressure spikes in the tube blank. Furthermore, a floor may be implemented on the remaining tube blank even as it is cut through thermally, this not being problematic in any way, since the necessary opening and therefore also the mouth shape may be introduced again through targeted heating of this end region. The disadvantage of elevated particle load on the open end region which may possibly result during the production of the tube blank may be compensated through this method, in particular through targeted heating.

The achievement of the object according to the present invention therefore offers, particularly in the mass production of glass receptacles, a significant economic advantage, through the use of a tube blank having an end region closed on one side and a ventilation hole, in relation to the known achievements of the object having an end region closed on both sides and a ventilation hole or an end region closed on one side without a ventilation hole. The preparation by detaching the region having the ventilation hole may be dispensed with, furthermore, the pressure ratios may be controlled reliably due to the ventilation hole present, so that they do not lead to negative interference in the manufacturing of glass receptacles.

In an especially advantageous embodiment, the heating of the second open end region is controlled as a function of the desired mouth shape. The advantage is that an opening having a desired diameter is achieved through the controlled heating.

According to a further advantageous embodiment of the present invention, the method is performed automatically. This offers the possibility of a high throughput, particularly in mass production.

The achievement according to the present invention is elucidated in the following with reference to figures. The following is illustrated in detail therein:

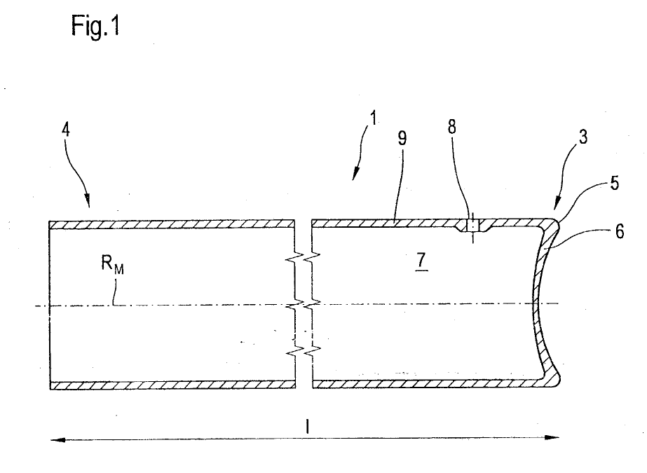

FIG. 1 elucidates a tube blank designed according to the present invention on the basis of a longitudinal section;

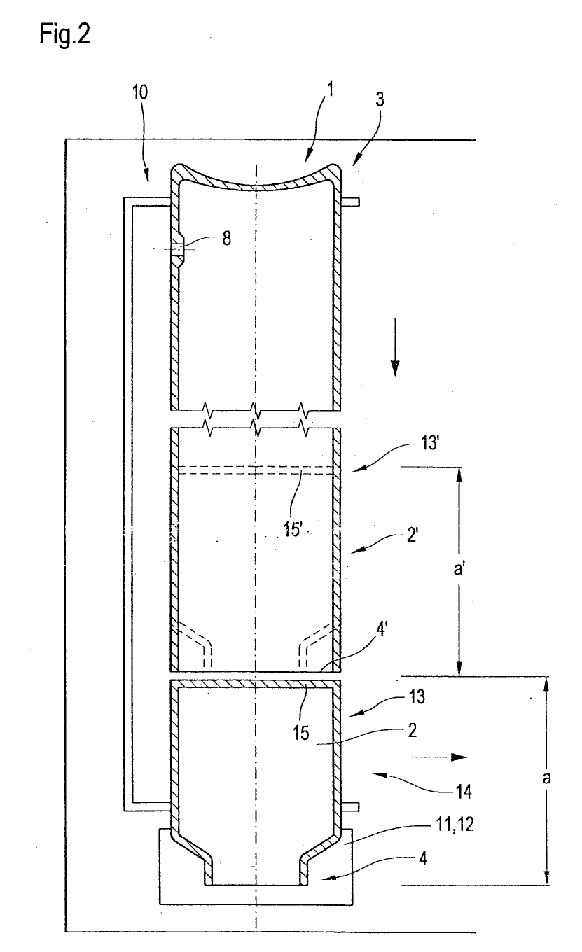

FIG. 2 elucidates a schematic, greatly simplified illustration of the basic principle of the method of producing glass receptacles, particularly those suitable for use in the pharmaceutical field.

FIG. 1 elucidates a schematic, greatly simplified illustration of a longitudinal section through a tube blank 1 designed according to the present invention, which is used to produce glass receptacles 2, which may be implemented, for example, in the form of glass vials, glass ampules, or glass syringes, and which are particularly suitable for pharmaceutical applications. Tube blank 1 is illustrated in longitudinal section in this case. It has two end regions, a first end region 3 and a second end region 4. First end region 3 is sealed in this case. For this purpose, a floor 6 is provided directly on tube end 5. The floor may be implemented, as in the case shown, as curved toward inner chamber 7 of the tube blank, which is delimited by the wall of the floor. A planar implementation of floor 6 (not shown here) is also conceivable. According to the present invention, tube blank 1 is also open in a second end region 4. In addition, a ventilation hole 8 is provided, which is introduced into wall 9 of tube blank 1 and preferably lies near floor 6. The ventilation hole is formed perpendicularly to tube central axis R_{M} in this case. It is also positioned in first end region 3.

Tube blank 1 is obtained in this case from a continuous glass tube strand of finite length. In this case, a tube element having length l, which forms tube blank 1, is detached from the glass tube strand. The tube element made in this case is opened on both end regions. One of the two open end regions of tube length l is then softened and drawn out by a force acting in the axial direction until the tube element collapses in this region and a first planar or slightly inwardly curved floor 6 is formed. The second end region, which then corresponds to open end region 4 in finished tube blank 1, remains untreated. The necessary run-out on the open end region is made possible in this case by the detachment from the glass tube strand, which is typically performed thermally. Ventilation hole 8 is then introduced into first end region 3. It is preferably applied using a spot burner.

To perform the method according to the present invention, tube blank 1 thus arising is then preferably inserted into a manufacturing machine 10 in such a way that closed end region 3 having ventilation hole 8 lies on top in the vertical direction. The manufacturing is performed beginning from open end region 4. In this case, tube wall 9 is moderately heated in open end region 4, for example using a device 11, the desired mouth for glass receptacle 2 being shaped using a device 12. Device for heating 11 and device for shaping 12 may also be combined into one unit in this case.

At a distance a from the open tube end, in particular the mouth which has already been introduced, tube blank 1 is then cut through thermally, a floor 15 forming on end region 13 of tube part 14 thus arising, which then forms glass receptacle 2, during the cutting. Glass receptacle 2 thus made is removed from manufacturing machine 10 corresponding to the direction of the arrow and the tube blank is guided downward and/or falls downward in the vertical direction. Second end region 4′, which results on remaining tube blank 1 after removal of glass receptacle 2, may either be closed again due to the thermal cutting, or may be provided with an opening. However, this does not play a role in the further manufacturing, since this second end region 4′ is again subjected to heating, also using device 11, and the desired mouth for glass receptacle 2′, i.e., the second glass receptacle obtained from tube blank 1, is formed using device 12 for shaping. The pressure ratios in tube blank 1 remain controllable due to existing ventilation hole 8. The resulting contour of glass tube vial 2′ is illustrated using a dashed line. Glass tube vial 2′ is then manufactured after vial 2 is removed from the machine or at least guided into the position illustrated in FIG. 2 for glass tube vial 2. Following the introduction of the mouth, the cutting procedure on tube blank 1 is again performed at a distance a′, end region 13′ of tube part 14′ thus arising being sealed by a floor 15′ during the cutting process and/or subsequently thereto. This process may now be continued until the end of tube blank 1, only the upper part having the ventilation hole being discarded. The manufacturing, beginning at the open end region, offers the advantage in this case that the production of glass receptacles may be begun immediately, without planning a part to be exploited, and the length of tube blank 1 available may be used optimally, since only the remaining end region having the ventilation hole is discarded and therefore no complicated calculations in regard to the size of the discard are necessary from the beginning, as in an embodiment with an end region closed on both sides.

List of reference numbers

| | |
|---|---|
| 1 | tube blank |
| 2, 2′ | glass receptacle |
| 3 | first end region |
| 4 | second end region |
| 5 | tube end |
| 6 | floor |
| 7 | inner chamber |
| 8 | ventilation hole |
| 9 | waIl |
| 10 | manufacturing machine |
| 11 | device for heating |
| 12 | device for shaping |
| 13, 13′ | end region |
| 14, 14′ | tube part |
| 15, 15′ | floor |
| R_{M} | tube central axis |
| a, a′ | distance |

What is claimed is:

1. A tube blank (1) for producing glass receptacles (2, 2′), in particular glass tube vials, glass ampules, or glass syringes, particularly those suitable for pharmaceutical applications, having a tube wall (9), including two end regions (3, 4)—a first end region (3) and a second end region (4)—the first end region (3) being sealed to form a floor (6) and a ventilation hole (8) being introduced into the tube wall (9) in the region of the end region (3), characterized in that the tube end characterizing the second end region (4) has an opening.

2. The tube blank (1) according to claim 1,
characterized in that the opening at the second end region (4) corresponds to the inner diameter of the tube wall (9).

3. The tube blank (1) according to one of claims 1 or 2,
characterized in that the tube wall (9) has a run-out of >0 and ≦0.8 mm at the second end region (4).

4. The tube blank (1) according to one of claims 1 to 3,
characterized in that the floor (6) formed in the first end region (3) is implemented as planar or curved toward the inner chamber (7) delimited by the tube wall (9).

5. A method of producing glass receptacles (2, 2′), in particular glass vials, glass ampules, or glass syringes, from a tube blank (1) according to one of claims 1 to 4,
wherein the tube blank (1) is inserted into a manufacturing machine and processed there into glass receptacles (2, 2′).

6. The method according to claim 5,
characterized by the following features:
6.1 the tube blank (1) is inserted into the manufacturing machine (10) in a vertical arrangement with the ventilation hole (8) on top;
6.2 the tube blank (1) is heated on the open end region (4) and the necessary mouth for the glass receptacle (2, 2′) is shaped;
6.3 the tube blank (1) is cut through at a distance from the resulting mouth which corresponds to the length of the glass receptacle, the floor (15, 15′) of the glass receptacle (2, 2′) being formed simultaneously;
6.4 the method steps 6.1 to 6.3 are repeated.

7. The method according to claim 6,
characterized in that the tube blank is cut through thermally.

8. The method according to one of claims 6 or 7,
characterized by the following features:
8.1 the glass receptacle (2, 2′) is removed from the region of the guide axis of the tube blank (1) in the manufacturing machine (10) after formation of the floor (15, 15′);
8.2 the tube blank (1) is guided along the guide axis by the distance of the length of the glass receptacle removed.

9. The method according to claim 8,
characterized in that, when the tube blank (1) is arranged vertically in the manufacturing machine (10), the guiding process occurs automatically through gravity.

10. The method according to one of claims 6 to 9,
characterized in that the heating of the open end region (4) is controlled.

11. The method according to one of claims 5 to 10,
characterized in that the individual glass receptacles (2, 2′) are manufactured continuously and sequentially in time.

12. The method according to one of claims 5 to 11,
characterized in that the production of the glass receptacles (2, 2′) is performed automatically.
